(19) United States
(12) Patent Application Publication
(10) Pub. No.: US 2005/0249031 A1
(43) Pub. Date: Nov. 10, 2005

(54) Color-coded flavored stirrer

(76) Inventors: Nicole S. Morgese, Brooklyn, NY (US); Donna Pavlicek, Naperville, IL (US)

Correspondence Address: LITMAN LAW OFFICES, LTD, PO BOX 15035, CRYSTAL CITY STATION, ARLINGTON, VA, 22215, US

(21) Appl. No.: 11/121,099

(22) Filed: May 4, 2005

Related U.S. Application Data
(60) Provisional application No. 60/567,775, filed on May 5, 2004.

(51) Int. Cl. B01F 13/00

(52) U.S. Cl. 366/129

(57) ABSTRACT

A color-coded flavored stirrer used to add condiments to and to stir a beverage. The color-coded stirrer has a hollow, cylindrical and elongated body with a proximal end and a distal end, the distal end of the hollow, cylindrical and elongated body being sealed closed, to hold the condiments within the hollow, cylindrical and elongated body. There is also a removable tip provided at the proximal end of the hollow, cylindrical and elongated body to allow for dispensing the condiments from the proximal end of the hollow, cylindrical and elongated body. The hollow, cylindrical and elongated body can be a specific color indicating the condiments being held within the hollow, cylindrical and elongated body.

### CROSS-REFERENCE TO RELATED APPLICATION

This application claims the benefit of U.S. Provisional Patent Application Ser. No. 60/567,775, filed May 5, 2004.

### BACKGROUND OF THE INVENTION

1. Field of the Invention

The present invention relates to a color-coded flavored stirring stick that can also distribute beverage condiments.

2. Description of the Related Art

Coffee is one of the most popular drinks in America. Literally millions of Americans start their morning with a fresh cup of coffee, most of which will use some kind of condiment such as milk, sugar or coffee creamer. Many condiments can be dispersed into a drink like coffee with the use of a flavoring stick or a stirring stick that has the capability to release flavoring or condiment from within the stirring stick. The use of both the stirring stick and the flavoring stick are well-known in the related art.

U.S. Pat. No. 3,824,322 issued to Fiorella on Jul. 16, 1974, outlines the use of a flavored stick implement for alcoholic beverages that contains flavoring held to the stirring portion of the implement that is communicable with the alcoholic beverage, so when the stirrer is moved through the alcoholic beverage, flavoring is dispensed and dissolved in the beverage. In the preferred embodiment, flavoring is held in the perforated hollow portion of the implement and circulates the beverage into contact with the flavoring during stirring.

U.S. Pat. No. 4,215,628 issued to Dodd, Jr. on Aug. 5, 1980, outlines the use of an infusion and stirring device with a handle member having a first and a second portion. A first and a second retaining element are secured to the first and the second portion of the handle member to stir into an infusion liquid upon movement of the handle member. The first and second retaining elements also engage opposite sides of a porous bag containing an infusion solid, such as a tea bag.

U.S. Pat. No. 4,387,809 issued to Botzler on Jun. 14, 1983, outlines the use of an integral multi-compartment package and stirrer device. A hollow tubular body is bonded together with end caps and one or more compartment separators are bonded inside the hollow tubular body. A die cut slot in the tubular body forms an opening to each compartment and the contents are contained in the compartments with a tear-away or perforated sealable tab affixed atop of each compartment-emptying slot.

U.S. Pat. No. 4,816,268 issued to Tsau on Mar. 28, 1989, outlines the use of a device for dispensing a comestible product into a liquid. The device has an exterior wall and an interior wall and at least one opening having a porous lattice structure communicable with the liquid in which the device is placed-in.

U.S. Pat. No. 4,849,231 issued to Spee on Jul. 18, 1989, outlines the use of a stirring rod with a stirring body and at least one holder for a substance to be added to a beverage arranged on the stirring body. The stirring rod has a holder for accommodating tea or coffee and a holder for accommodating sugar therein. Each holder has a reservoir in which granular material is located, whereby a wall of the reservoir is provided with perforations to provide liquid with access to the granular material.

U.S. Pat. No. 4,860,929 issued to Lowe et al. on Aug. 29, 1989, outlines the use of a dispensing device for a soluble granular material. The device has a tube formed of a liquid-impermeable material with a unitary construction, the tube being closed at both ends and having perforations along a portion of its length at or close to one end and also containing a solid granular material.

U.S. Pat. No. 5,125,534 issued to Rose et al. on Jun. 30, 1992, outlines the use of a beverage flavoring and dispensing device for use in consumable fluid. More particularly, the device relates to a beverage flavoring and dispensing device and method of construction of the type having an upper body chamber which serves as a storage area and a mixing handle and a dissolvable lower housing with multiple compartments for carrying and dispensing a plurality of comestible ingredients into a fluid.

U.S. Pat. No. 5,440,976 issued to Giuliano et al. on Aug. 15, 1995, outlines the use of an adjustable dispenser stirrer stick for sweeteners, such as sugar or artificial sweeteners. The stirrer stick incrementally dispenses a desired sweetener while the beverage being sweetened, such as coffee, is stirred.

U.S. Pat. No. 5,866,185 issued to Burkett on Feb. 2, 1999, outlines the use of a dispensing device for a soluble or dispersible material, which has a tube formed from a liquid impermeable material with unitary construction, the tube being closed at both ends and having perforations along a portion of its length or close to one end, and containing a soluble granular material. The device is coated with a material such as sugar or Nutrasweet, the material being rigid in the dry state and soluble when immersed in a liquid.

U.S. Pat. No. 6,399,126 issued to Weldon, Jr. on Jun. 4, 2002, outlines the use of a flavored beverage stirrer that includes a carrier and a cartridge. The carrier includes a cap to which is attached an elongated member or wand with barbs or protrusions extending outwardly from its length. The stirrer also includes a cartridge formed from a flavored material. The cartridge is generally in the shape of a cylinder with a hole extending therethrough. The cartridge is placed onto the wand so that the barbs of the wand fit within the grooves formed within the hole of the cartridge, thereby retaining the cartridge on the elongated member.

W.I.P.O. Publication Number WO 99/09871 granted to Schleider on Mar. 4, 1999, outlines the use of a straw having a flavor-producing coating on its outer surface. The straw acts to flavor liquids and can substitute or compliment existing garnishes, thus enhancing the flavor and enjoyment of various mixed beverages. When the straw is used as a drinking straw, the carrier adhesive melts, releasing flavor agent particles into direct contact with the consumer's tongue stimulating the taste buds. When the straw is used as a stirrer in liquids, the carrier adhesive melts releasing flavor agent particles, thus imparting flavoring to the liquid.

Although each of these patents outlines the use of novel and useful devices, what is really needed is a color-coded stirring stick that can distribute specifically color-coded condiments into a beverage. Such a device would address a large demand for a color-coded stirring straw that dispenses desired condiments into beverages in the marketplace.

None of the above inventions and patents, taken either singly or in combination, is seen to describe the instant invention as claimed. Thus a color-coded flavored stirrer solving the aforementioned problems is desired.

### SUMMARY OF THE INVENTION

The invention is a color-coded flavored stirrer used to add condiments to and to stir a beverage. The color-coded stirrer has a hollow, cylindrical and elongated body with a proximal end and a distal end, the distal end of the hollow, cylindrical and elongated body being sealed closed, to hold the condiments within the hollow, cylindrical and elongated body. There is also a removable tip provided at the proximal end of the hollow, cylindrical and elongated body to allow for dispensing the condiments. The removable tip is a perforated tip that can be torn off to allow for the dispensing of the condiments within the hollow, cylindrical and elongated body. The hollow, cylindrical and elongated body can be a specific color indicating the condiments being held within the hollow, cylindrical and elongated body.

Accordingly, it is a principal object of the invention to provide a color-coded flavored stirrer.

It is another object of the invention to provide a way for a person drinking coffee, tea or some other beverage to easily add beverage condiments and stir their beverage.

It is a further object of the invention to provide a cheap, disposable, convenient and mobile way for a person drinking coffee, tea or some other beverage to add condiments to and to stir their respective beverage.

Still another object of the invention is to provide an easy way for a person to add spices such as cinnamon, nutmeg and eggnog and to stir a beverage.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a color-coded flavored stirrer according to the present invention.

FIG. 2 is a partially cut-a-way side view of the color-coded flavored stirrer.

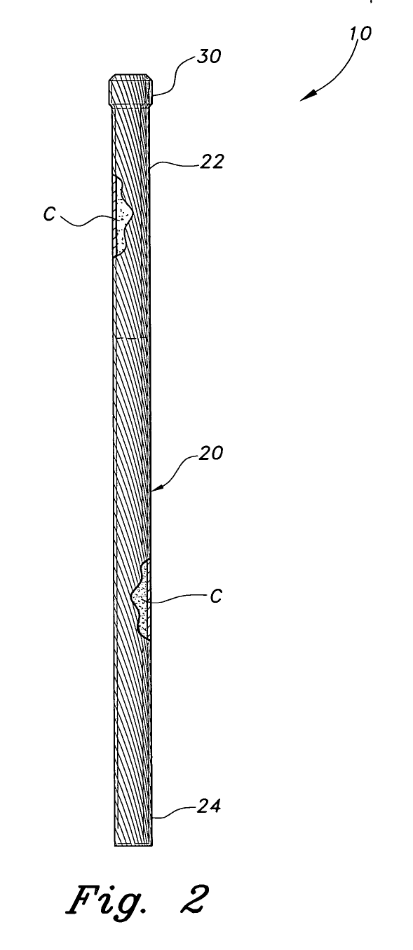

Similar reference characters denote corresponding features consistently throughout the attached drawings.

### DETAILED DESCRIPTION OF THE PREFERRED EMBODIMENT

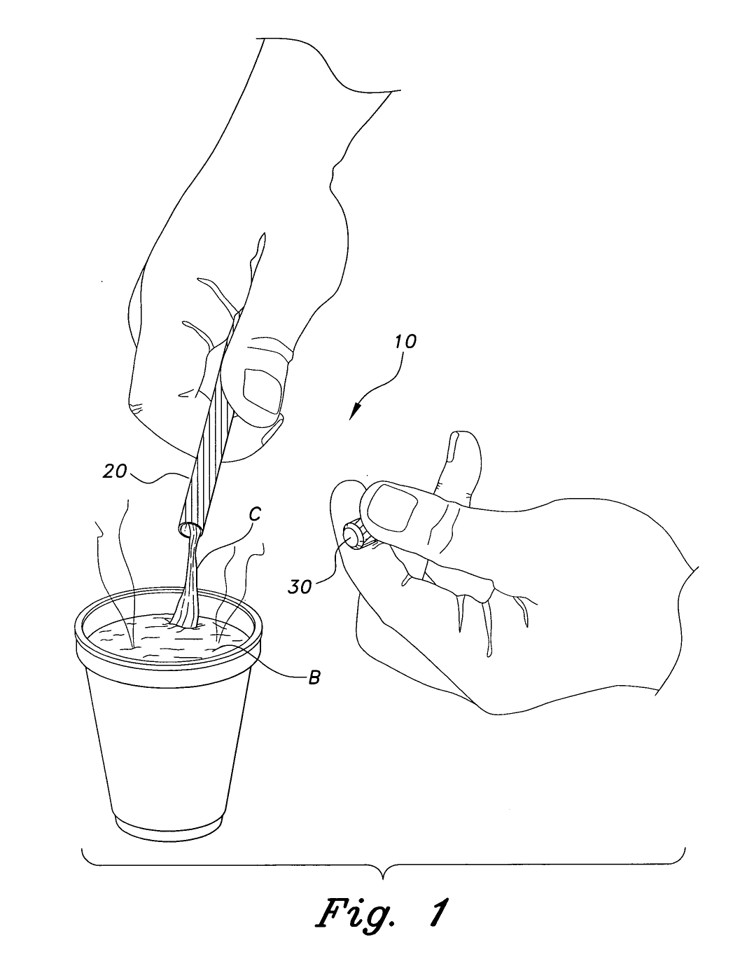

The present invention is a color-coded flavored stirrer 10 used to add condiments C to and to stir a beverage B, as is depicted in FIG. 1.

The color-coded flavored stirrer 10 comprises a hollow, cylindrical and elongated body 20 with a proximal end 22 and a distal end 24, the distal end 24 of the hollow, cylindrical and elongated body 20 being sealed closed, to hold the condiments C within the hollow, cylindrical and elongated body 20. The color-coded flavored stirrer 10 further comprises a removable tip 30 provided at the proximal end 22 of the hollow, cylindrical and elongated body 20 to allow for dispensing the condiments C of the hollow, cylindrical and elongated body 20. In a preferred embodiment, removable tip 30 is a perforated tip that can be easily torn from hollow, cylindrical and elongated body 20. Hollow, cylindrical and elongated body 20 is provided with a specific outer color for indicating what the specific condiments C being held within the hollow, cylindrical and elongated body 20 are.

The hollow, cylindrical and elongated body 20 is colored according to a color-coding scheme describing the contents of the color-coded flavored stirrer 10. For example, a color-coded flavored stirrer 10 with a white colored hollow, cylindrical body 20 would hold cream as a condiment C. Another example is a color-coded flavored stirrer 10 with a red hollow, cylindrical and elongated body 20, which would hold the condiments C cream and sugar.

There are several other color-coded colors that indicate other condiments C being held in the color-coded flavored stirrer 10. For example, when the color of the hollow, cylindrical and elongated body 20 is pink, the color-coded flavored stirrer 10 will be holding the condiment C artificial sugar as the condiment C. Additionally, when the color of the hollow, cylindrical and elongated body 20 is green, the color-coded flavored stirrer 10 will be holding the condiment C of mint flavoring, which could be used during the holidays. For example, when the color of the hollow, cylindrical and elongated body 20 is brown, the color-coded flavored stirrer 10 will be holding the condiment C cinnamon. Also, when the color of the hollow, cylindrical and elongated body 20 is beige, the color-coded flavored stirrer 10 will be holding the condiment C eggnog.

Use of the color-coded flavored stirrer 10 is straightforward. First, a user would select a color-coded flavored stirrer 10 based on the color-coded scheme previously discussed. Once selected, the user would take the removable tip 30 off of the color-coded flavored stirrer 10 and simply pour the desired condiments C into their respective beverage B, which is usually coffee or tea. After one or more condiments C has been emptied into the beverage B, hollow, cylindrical and elongated body 20 can be used as a stirring stick for stirring condiments C into beverage B. Regardless of the color and condiments C within the color-coded flavored stirrer 10, the hollow, cylindrical and elongated body 20 is made of colored plastic, which can be easily molded and shaped for easy manufacturing and low-costs.

It is to be understood that the present invention is not limited to the embodiments described above, but encompasses any and all embodiments within the scope of the following claims.

1. A device for adding condiments to and stirring a beverage, comprising:
a hollow elongated body with a proximal end and a distal end, the distal end of the hollow elongated body being sealed closed, wherein condiments are stored within the hollow elongated body; and
a removable tip provided at the proximal end of the hollow elongated body.

2. The device for adding condiments to and stirring a beverage according to claim 1, wherein the hollow elongated body and removable tip are colored for indicating the specific condiments being stored within the hollow elongated body.

3. The color-coded stirrer for adding condiments to and stirring a beverage according to claim 1, wherein the removable tip is a perforated tip.

4. The color-coded stirrer for adding condiments to and stirring a beverage according to claim 3, wherein the hollow elongated body is cylindrical.

5. The color-coded stirrer for adding condiments to and stirring a beverage according to claim 4, wherein the hollow elongated body and removable tip are made from plastic.

6. A color-coded stirrer for adding condiments to and stirring a beverage, comprising:
a hollow elongated body with a proximal end and a distal end, the distal end of the hollow elongated body being sealed closed, wherein condiments are stored within the hollow elongated body; and
a removable tip provided at the proximal end of the hollow elongated body;
wherein the hollow elongated body and removable tip are colored for indicating the specific condiments being stored within the hollow elongated body.

7. The color-coded stirrer for adding condiments to and stirring a beverage according to claim 6, wherein the removable tip is a perforated tip.

8. The color-coded stirrer for adding condiments to and stirring a beverage according to claim 7, wherein the hollow elongated body is cylindrical.

9. The color-coded stirrer for adding condiments to and stirring a beverage according to claim 8, wherein the hollow elongated body and removable tip are made from plastic.
